(19) United States
(12) Patent Application Publication
(10) Pub. No.: US 2015/0229523 A1
(43) Pub. Date: Aug. 13, 2015

(54) VIRTUAL EXTENSIBLE LOCAL AREA NETWORK (VXLAN) SYSTEM OF AUTOMATICALLY CONFIGURING MULTICASTING TUNNEL FOR SEGMENT OF VIRTUAL EXTENSIBLE LOCAL AREA NETWORK ACCORDING TO LIFE CYCLE OF END SYSTEM AND OPERATING METHOD THEREOF

(71) Applicant: Electronics and Telecommunications Research Institute, Daejeon (KR)

(72) Inventors: Soo Myung PARK, Daejeon (KR); Sun Me KIM, Daejeon (KR); Tae Il KIM, Daejeon (KR); Sung Hyuk BYUN, Daejeon (KR); Chang Gyu LIM, Daejeon (KR)

(21) Appl. No.: 14/619,401

(22) Filed: Feb. 11, 2015

(30) Foreign Application Priority Data
Feb. 11, 2014 (KR) 10-2014-0015281

(51) Int. Cl. H04L 12/24; H04L 12/931

(52) U.S. Cl. CPC H04L 41/0823; H04L 49/70

(57) ABSTRACT

Provided is an operating method of a database server in a Virtual eXtensible Local Area Network (VXLAN) system including a network administrator, the database server, a switch and at least one end system. The database server may maintain a table including information about a network profile and information about a service profile, receive, from the switch, a request for information on a virtual station interface (VSI) type corresponding to a request message for setting up and canceling a VXLAN service that the switch receives from the at least one end system, retrieve a network property corresponding to the VSI type from the table in response to the request, and provide the retrieved network property to the switch.

### CROSS-REFERENCE TO RELATED APPLICATION

This application claims the priority benefit of Korean Patent Application No. 10-2014-0015281, filed on Feb. 11, 2014, in the Korean Intellectual Property Office, the disclosure of which is incorporated herein by reference.

### BACKGROUND

1. Field of the Invention

Embodiments of the present invention relate to a Virtual eXtensible Local Area Network (VXLAN) system of automatically configuring a multicasting tunnel for a segment of VXLAN according to a life cycle of an end system, and an operating method thereof.

2. Description of the Related Art

Technologies for components in cloud services and an Internet data centers (IDCs) are rapidly developing. With such technological advancement, demands of IDC network systems are increasing so as to meet network requirements due to service changes. Smart IDC network systems equipped with, for example, network control technology optimized for a cloud service, network control technology for enhancing efficiency in utilization of network resources and communications efficiency, integrated control technology for cloud/network resources, and high-reliability integrated network control technology are required.

As to smart IDC network systems, standardization of Internet Engineering Task Force (IETF) Transparent Interconnection of Lots of Links (TRILL), Institute of Electrical and Electronics Engineers (IEEE) 802.1 Qbh Bridge Port Extension, IEEE802.1Qbg Edge Virtual Bridging (VSI Discovery and Configuration Protocol (VDP), S-Channel Discovery and Configuration Protocol (CDCP), and Edge Control Protocol (ECP)), and Virtual eXtensible Local Area Network (VXLAN) technology are being studied or have been achieved.

### SUMMARY

According to an aspect of the present invention, a Virtual eXtensible Local Area Network (VXLAN) service for a tenant network that an end system belongs to may be automatically set up or canceled according to a life cycle of the end system.

According to an aspect of the present invention, there is provided a Virtual eXtensible Local Area Network (VXLAN) system including: a database (DB) server to maintain a table including information about a network profile and information about a service profile and to retrieve and provide a network property corresponding to information on a requested virtual station interface (VSI) type from the table; a network administrator to perform at least one of management operations of registering, deleting and updating the information on the VSI type; a switch to receive a request message for setting up or canceling a VXLAN service to identify a life cycle of an end system, and to configure a VXLAN service associated with a virtual local area network (VLAN) identifier (ID) of the end system; and at least one end system to transmit the request message for setting up or canceling the VXLAN service to the switch and to use the VXLAN service based on a result of setting up or canceling the service.

The VXLAN system may set up or cancel a VXLAN service for a tenant network that the at least one end system belongs to according to the life cycle of the end system.

According to another aspect of the present invention, there is provided an operating method of a DB server in a VXLAN system including a network administrator, the DB server, a switch and at least one end system, the method including: maintaining a table including information about a network profile and information about a service profile; receiving, from the switch, a request for information on a VSI type corresponding to a message that the switch receives from the at least one end system, the message being a request message for setting up and canceling a VXLAN service; retrieving a network property corresponding to the VSI type from the table in response to the request; and providing the retrieved network property to the switch.

The retrieving of the network property may include retrieving the network property corresponding to the VSI type based on an ID and a version (VER) of the VSI type included in the message.

The table may include at least one of a property of a layer 2 network profile, a property of a VXLAN service profile and a multicast group address.

The property of the layer 2 network profile and the property of the VXLAN service profile may include at least one of a VLAN ID, Quality of Service (QoS), a bandwidth (B/W) and a VXLAN identifier (VNI).

The method may further include receiving information on a VSI type input by the network administrator, the information on the VSI type being used by the at least one end system; and storing the input information on the VSI type in the table.

The network administrator may perform at least one of management operations of registering, deleting and updating the information on the VSI type in the table.

According to still another aspect of the present invention, there is provided an operating method of a switch in a VXLAN system including a network administrator, a DB server, the switch and at least one end system, the method including receiving a request message for setting up or canceling a VXLAN service from the at least one end system; requesting information on a VSI type corresponding to the message from the DB server; receiving a network property corresponding to the VSI type from the DB server; and setting up or canceling the VXLAN service using the network property.

The setting up or canceling of the VXLAN service may include setting up or canceling a layer 2 network profile using the network property; and setting up or canceling a VXLAN service profile using the network property.

The network property may be a network property corresponding to the VSI type in a table stored in the DB server.

The network property may include a property of a layer 2 network profile and a property of a VXLAN service profile.

The method may further include transmitting a result of setting up or canceling the VXLAN service based on the message to the at least end system.

The message may be a request message for setting up or canceling a VXLAN service according to Edge Virtual Bridging (EVB) or VSI Discovery and Configuration Protocol (VDP) and include an ID and version (VER) information of the VSI type.

The method may further include registering an address of the DB server storing information on a VSI type.

According to yet another aspect of the present invention, there is provided an operating method of an end system in a VXLAN system including a network administrator, a DB server, a switch and at least one end system, the method including transmitting a request message for setting up or canceling a VXLAN service to a switch adjacent to the end system; receiving a result of setting up or canceling the VXLAN service from the switch; and using the VXLAN service according to the received result.

The method may further include retrieving a network interface connected to the switch adjacent to the end system when the end system performs a booting process or downloads a program.

The transmitting of the message may include transmitting a request message for setting up or canceling the service through the network interface connected to the switch.

The transmitting of the message may include transmitting an association message to the switch when the end system performs the booting process.

The transmitting of the message may include transmitting a de-association message to the switch when the end system downloads the program.

As described above, according to an aspect of the present invention, a VXLAN service for a tenant network that an end system belongs to may be automatically set up or canceled according to a life cycle of the end system, there by remarkably reducing frequency of errors in network setup.

Further, according to an aspect of the present invention, a switch may identify a life cycle of an adjacent end system through a VSI Discovery and Configuration Protocol (VDP) message of the end system and set up or cancel a VXLAN service associated with a VLAN ID (VID) of the end system not to set up a VXLAN service for an unrequested tenant network, thereby reducing work load.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates Virtual eXtensible Local Area Network (VXLAN) and Institute of Electrical and Electronics Engineers (IEEE) 802.1Qbg Edge Virtual Bridging for VXLAN according to an exemplary embodiment;

FIG. 2 illustrates a VXLAN structure according an exemplary embodiment;

FIG. 3 illustrates a packet transmission mode between VXLAN Tunnel End Points (VTEPs) in a VXLAN system according to an exemplary embodiment;

FIG. 4 is a flowchart illustrating operations of components of a VXLAN system according to an exemplary embodiment;

FIG. 5 is a flowchart illustrating an operating method of a database server in a VXLAN system according to an exemplary embodiment;

FIG. 6 is a flowchart illustrating an operating method of a switch in a VXLAN system according to an exemplary embodiment; and

FIG. 7 is a flowchart illustrating an operating method of an end system in a VXLAN system according to an exemplary embodiment.

### DETAILED DESCRIPTION

Hereinafter, exemplary embodiments will be described in detail with reference to the accompanying drawings. However, the present invention is not limited or restricted by the exemplary embodiments. Like reference numerals refer to like elements throughout.

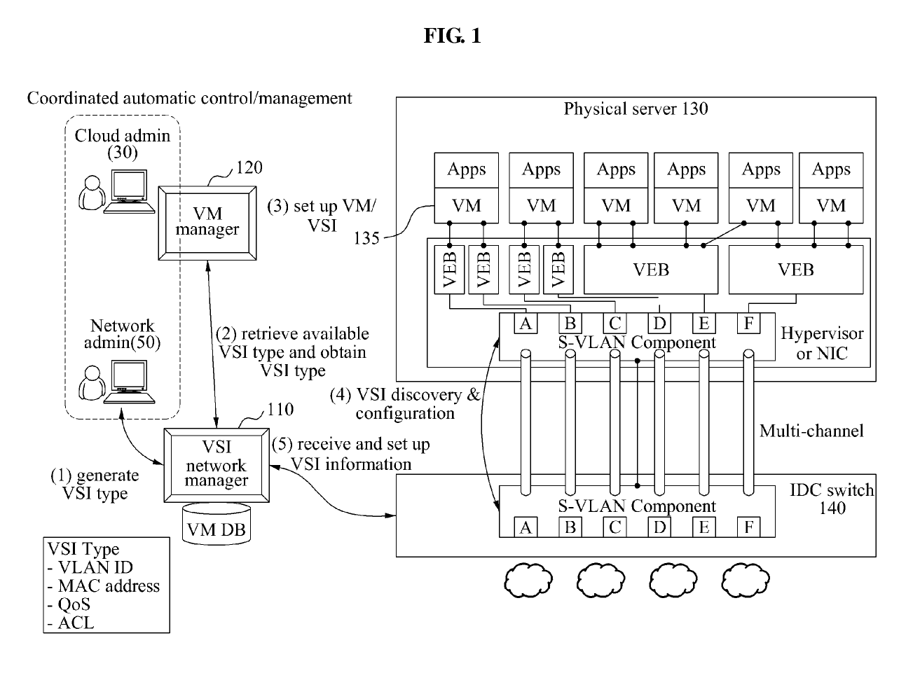

FIG. 1 illustrates Virtual eXtensible Local Area Network (VXLAN) and Institute of Electrical and Electronics Engineers (IEEE) 802.1Qbg Edge Virtual Bridging for VXLAN according to an exemplary embodiment.

An IEEE 802.1Qbg standard is a core technology for auto-managed Internet data center (IDC) network control. IEEE 802.1Qbg enables smart setup between a cloud service server area and a network service area for avoiding time-consuming operation due to management by manual setup between a cloud server and a network with an expanding scope of an IDC network for a cloud service.

That is, IEEE 802.1Qbg may provide real-time coordinated automatic control and management of a virtual resource of a cloud and a network resource, as shown in FIG. 1. IEEE 802.1Qbg may secure continuity and quality of a cloud service by virtual machine (VM) migration even when a hindrance occurs to physical resources. Accordingly, cloud resources and network resources in an IDC may be maximally utilized, and operation and management costs may be also saved due to consistent operation.

In FIG. 1, a network manager 110 (virtual station interface (VSI) network manager) 110 may manage property information on a network, for example, information on a VSI type, to be used by VMs 135, that is, end systems. The VSI network manager 110 may retrieve an available VSI type from a VM manger 120 and acquire VSI type information.

The acquired VSI type information may be manually managed by an IDC switch 140 or managed by a database (DB) management server, for example, VSI type DB server, which stores information on a VSI type.

The VSI type information may include a virtual local area network (VLAN) identifier (ID), a media access control (MAC) address, Quality of Service (QoS), an access control list (ACL), and various properties for services needed by the VMs 135.

The VMs 135 in a physical server (virtual server) 130 using specific VSI type information request the IDC switch 140 directly connected to the physical server 130 to set up a network property, that is, a VIS type, that the VMs 135 are to use. The IDC switch 140 provides a network service to the VMs 135 based on the property corresponding to the VSI type, thereby automatically controlling and managing the VMs and a network in an integrated manner and securing continuity and quality of the VMs.

Setting up network equipment is a very delicate operation. Thus, setting up a wrong network may not only disturb network connectivity of a VM but also discontinue a cloud service provided by an IDC.

A cloud administrator 30 and a network administrator 50 are required to set up a network for securing consistent quality without discontinuation of the cloud service and to efficiently operate the network despite a change in a status of the VMs, for example, by booting, interruption of an operation and migration.

Here, VSI Discovery and Configuration Protocol (VDP) of the IEEE802.1Qbg Edge Virtual Bridging standard may be used for efficient operation.

VSI VDP is a technology which is used between the physical server 130 and the IDC switch 140 and automatically sets up a network based on a network property defined in a VSI type between the physical server 130 that the VM 135 migrates to and an adjacent switch 140.

The IDC switch 140 may request, from the VSI type DB server, information on a network property of a VSI type requested by a specific VM in the virtual server 130. The IDC switch 140 may set up a network service requested by the VM based on the information on the network property received from the VSI type DB.

VXLAN technology, which provides extension of VLAN, may build a subscriber network of a cloud service as an extended layer 2 network over a layer 3 (3-Layer) network and overcome constraints by a VID to distinguish a tenant network by using a VXLAN identifier (VNI).

Hereinafter, layer 2 may be also referred to layer-2 or L2.

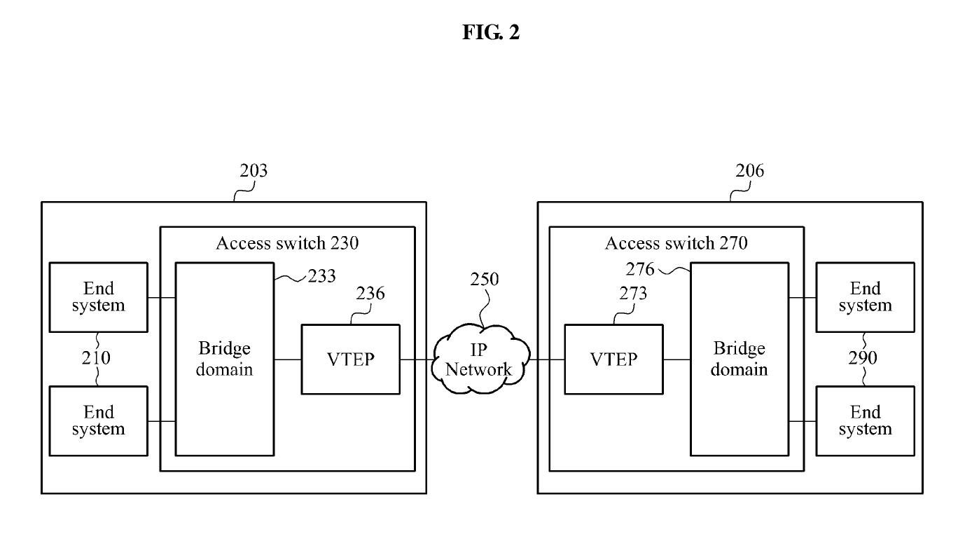

FIG. 2 illustrates a VXLAN structure according an exemplary embodiment.

FIG. 2 illustrates layer 2 networks 203 and 206 connected to a layer 3 network 250.

A layer 2 network 203 is encapsulated by an Internet/User Datagram Protocol (IP/UDP) as a VXLAN tunnel at a VXLAN Tunnel End Point (VTEP) 236 to be connected to the layer 3 network 250, and then to be connected to another remote layer 2 network 206 via the layer 3 network 250, thereby forming a single logical layer 2 network. Here, encapsulation by the IP/UDP may be added to a VXLAN header.

VTEPs 236 and 273 may be disposed at bridge domains of virtual access switches of physical servers in which end systems 210 and 290 are positioned or at bridge domains of adjacent physical access switches 230 and 270 connected to the physical servers.

The bridge domains 233 and 276 of the access switches 230 and 270 where the VTEPs 237 and 273 are disposed may have two types of interfaces. One interface is a bridge domain trunk interface of the access switches 230 and 270, and another interface is an interface connected to the layer 3 network (IP network) 250 to serve as an IP host. Here, the end systems 210 and 290 may be the physical servers or VMs in the physical servers.

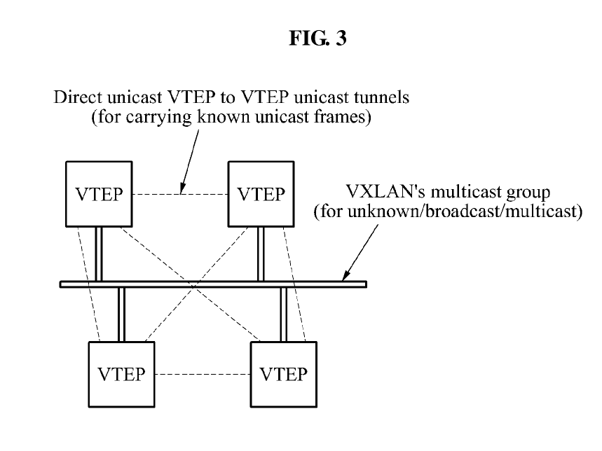

FIG. 3 illustrates a packet transmission mode between VTEPs in a VXLAN system according to an exemplary embodiment.

FIG. 3 shows a VXLAN tunnel connection mode according to a traffic type between the VTEPs.

For example, suppose that there are a remote VTEP IP and MAC address corresponding to a destination MAC address of traffic transmitted from an end system to a VTEP via a port of a bridge domain or VLAN interface.

The VTEP may set up a destination MAC address, a VTEP IP address and VLAN ID information associated with the port or VLAN interface, which are needed for a VXLAN header, based on the information, that is, the remote VTEP IP and MAC address corresponding to the destination MAC address of the traffic.

Subsequently, the VTEP may IP/UDP-encapsulate the set information into a packet through a VXLAN tunnel and transmit the packet to a layer 3 network. A remote VTEP receiving the packet through the layer 3 network removes the VXLAN header and transmits the packet to a port of a bridge domain or VLAN interface associated with a VXLAN network identifier (VNI).

For instance, suppose that there are no remote VTEP IP and MAC address corresponding to a destination MAC address of traffic transmitted from an end system to a VTEP via a bridge domain or a traffic type is broadcast traffic or multicast traffic.

The VTEP may IP/UDP-encapsulate the traffic through the VXLAN tunnel based on a multicast group address of a VNI associated with a port or VLAN interface through which the traffic is transmitted, and transmits the traffic to the layer 3 network.

In a cloud environment, an end system is generally connected to a bridge domain through a port of an adjacent switch or VLAN interface. The bridge domain may be distinguished by a layer 2 network used by a tenant that the end system is grouped in, that is, a tenant network.

In the cloud environment, a switch is able to accommodate an up to 4-K network using VLAN technology but may not accommodate a more than 4-K tenant network. A tenant network may be distinguished by a VNI using a VXLAN recognizing switch adopting VXLAN technology, thereby configuring a tenant network of 4K or greater.

Generally, when configuring a tenant network using a VLAN domain, VNIs may be set up in association with at most 4095 VIDs, respectively, and a multicast group tunnel for each VNI may be set up. However, a manual process of setting up all tenant networks for all switches providing a gateway service of VXLAN in the cloud environment may increase frequency of errors in network setup.

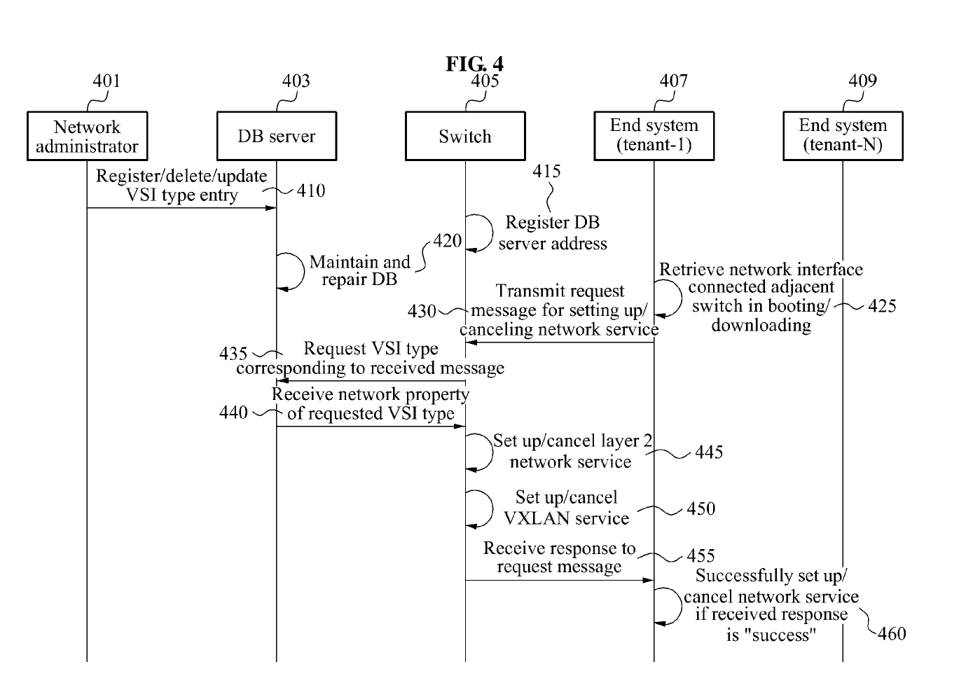

In one exemplary embodiment, as shown in FIG. 4, a VXLAN service for a tenant network is automatically set up according to a life cycle of an end system, thereby reducing an error in network setup.

FIG. 4 is a flowchart illustrating operations of components of a VXLAN system according to an exemplary embodiment.

FIG. 4 shows operations of automatically registering and canceling a multicasting channel according to a life cycle of an end system.

The VXLAN system may include a network administrator 401, a DB server 403, a switch 405, and end systems 407 and 409.

The network administrator 401 may manage a network in an IDC providing a cloud service, and register, delete and update a VSI type entry, for example, content of one row in Table 1, used by the end systems 407 and 409 in the DB server 403.

The DB server 403 may maintain a table including information about a network profile and information about a service profile. Here, the table may be a VSI type DB table. Further, the DB server 403 may retrieve a network property corresponding to information on a requested VSI type from the table and provide the network property to the switch 405. The DB server 403 may be, for example, a VSI type DB server.

The switch 405 may receive a request message for setting up or canceling a VXLAN service from at least one adjacent end system 407 or 409 and recognize a life cycle of the end system. Further, the switch 405 may configure a VXLAN service associated with a VID of the end system. Here, the request message for setting up or canceling the VXLAN service may be, for instance, an Edge Virtual Bridging (EVB)/VSI discovery and configuration protocol (VDP) message.

The end systems 407 and 409 may transmit a request message for setting up or canceling the VXLAN service to the switch 405 and use the VXLAN service depending on a setting or canceling result. Here, an end system 407 may belong to a tenant-1, and an end system 409 may belong to a tenant-N.

As such, the VXLAN system according to the present embodiment may automatically set up or cancel the VXLAN service for a tenant network that the end systems 407 and 409 belong to according to life cycles of the end systems 407 and 409, thereby remarkably reducing frequency of errors in network setup.

Moreover, the VXLAN system, particularly the switch 405, may not set up a VXLAN service for an unrequested tenant network, that is, may not perform a task that needs to be conducted by each VNI at a VTEP, such as processing a broadcast message or multicast message, thereby reducing work load.

Hereinafter, operations of each component in the VXLAN system according to the present embodiment will be described.

The network administrator 401 may register, delete and update a VSI type entry used by the end systems 407 and 409 in the DB server 403 in operations 410.

The switch 405 may set up an address of the DB server 403 needed for obtaining VSI type information in operation 415. Here, setting up the address of the DB server 403 is not necessarily performed after operation 410, but may be also performed before operation 410 or after operation 420.

The DB server 403 may maintain or repair a DB based on the VSI type entry registered, deleted and updated by the network administrator 401 in operation 420.

The end system 407 may retrieve a network interface connected to the adjacent switch 405 when performing a booting process or downloading process in operation 425 and transmit a request message for setting up or canceling a network service to the retrieved network interface in operation 430. When performing the booting process, the end system 407 may transmit an association message in operation 430. When performing the downloading process, the end system 407 may transmit a de-association message.

The switch 405 may receive a message, for example, an EVB/VDP message, transmitted from the end system 407 and request a VSI type corresponding to the message from the DB server 403.

The switch 405 may receive a network property of the VSI type requested in operation 403 from the DB server 403 in operation 440. Here, the network property that the switch 405 receives from the DB server 403 is a result of retrieving the DB based on an ID and version of the VSI type included in a message requesting the DB server 403 to transmit the VSI type in operation 435.

The switch 405 may set up or cancel a layer 2 network service based on the network property received from the DB server 403 in operation 445, and set up or cancel a VXLAN network service in operation 450. Here, the network property received from the DB server 403 may be, for example, a property of a layer 2 network profile and a property of a VXLAN service profile.

The end system 407 may receive a response to the request message from the switch 405 in operation 455. If the received response is “success,” the end system 407 may verify that the adjacent switch 405 successfully sets up or cancels the layer 2 network service and the VXLAN service.

Subsequently, the end system 407 may use the layer 2 network service and the VXLAN service set up with the requested network profile, or cancel a network service being used.

The end system 409 may also perform the same processes as operations 425 to 460, thereby using the layer 2 network service and the VXLAN service set up with a requested network profile, or cancelling a network service being used.

As described above, in the present embodiment, the VXLAN service for the tenant network that the end systems 407 and 409 belong to may be automatically set up according to the life cycles of the end systems 407 and 409.

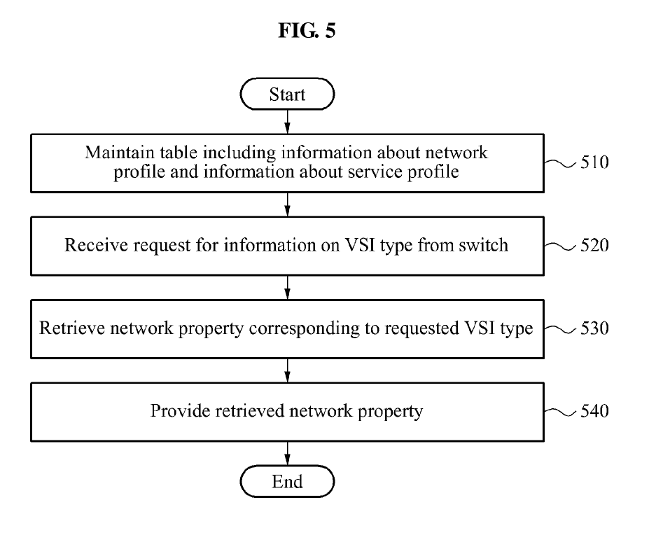

FIG. 5 is a flowchart illustrating an operating method of a DB server in a VXLAN system according to an exemplary embodiment.

Referring to FIG. 5, the DB server according to the present embodiment may maintain a table including information about a network profile and information about a service profile in operation 510. Here, the table may be a VSI type DB table, which may have a configuration as in Table 1.

The configuration of the table may be changed and modified variously, without being limited to Table 1. The table may include an ID, version information, Quality of Service (QoS) and a bandwidth (B/W) of a VSI type in addition to a VID as a property of a layer 2 network profile and a property of a VXLAN service profile, a VNI and a multicast group address.

TABLE 1
VSI Type DB Table

| | | | | | | Multicast Group |
|---|---|---|---|---|---|---|
| VSI Type ID | VER | VID | QoS | B/W | VNI ID | Address |
| 10 | 1 | 20 | 10 | 20 | 100010 | 224.0.0.10 |
| 20 | 1 | 80 | 5 | 50 | 100080 | 224.0.0.11 |
| . . . | . . . | . . . | . . . | . . . | . . . | . . . |

All end systems may be provided with an integrated network service according to a network profile including a layer 2 network service and a VXLAN service based on information about a VSI type registered in the VSI type DB table.

For example, an end system which requests a network service with a VID type ID of 10 and VER value of 1 may be provided with a layer 2 network service having a VID of 20 and a QoS of 10 and a B/W of 20 and provided with a VXLAN service having a VNI of 10010.

The DB server may receive, from a switch, a request for information on a VSI type corresponding to a message that the switch receives from at least one end system in operation 520. Here, the message may be a request message for setting up and canceling a VXLAN service.

In response to the request in operation 520, the DB server may retrieve a network property corresponding to the requested VSI type from the table in operation 530.

In operation 530, the DB server may retrieve the network property corresponding to the requested VSI type based on an ID and version of the VSI type included in the message that the switch receives from the at least one end system, specifically the request for the information on the VSI type.

The DB server may provide the retrieved network property to the switch in operation 540.

In addition, the DB server may receive information on a VSI type input by a network administrator and store the information on the VSI type in the table. Here, the information on the VSI type may be used by at least one end system.

The network administrator may perform at least one of operations of registering, deleting and updating the information on the VSI type in the table.

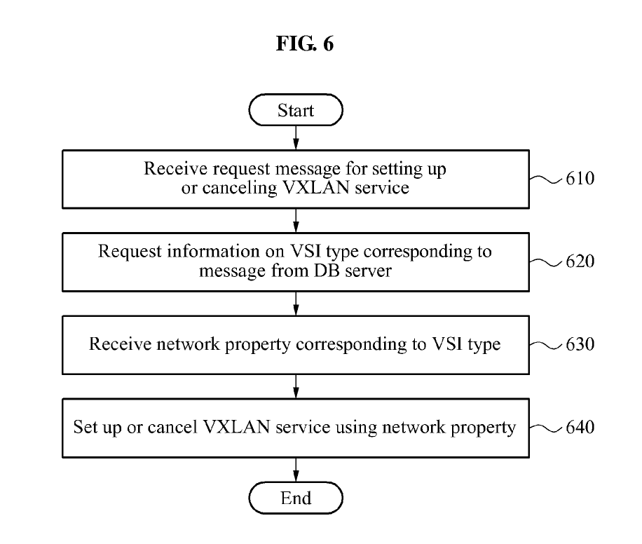

FIG. 6 is a flowchart illustrating an operating method of a switch in a VXLAN system according to an exemplary embodiment.

Referring to FIG. 6, the switch according to the present embodiment may receive a request message for setting up or canceling a VXLAN service from at least one end system in operation 610. The request message for setting up or canceling the VXLAN service may be, for example, a request message for setting up and canceling a VXLAN service according to EVB or VDP and may include an ID and version information of a VSI type.

The switch may request information on a VSI type corresponding to the message from a DB server in operation 620. Before operation 620, the switch may register an address of the DB server storing information about a VSI type in advance in the switch.

The switch may receive a network property corresponding to the VSI type from the DB server in operation 630. Here, the network property received by the switch may be a network property corresponding to the VSI type, requested in operation 620, stored in a table of the DB server. The network property may include a property of a layer 2 network profile and a property of a VXLAN service profile.

The switch may set up or cancel the VXLAN service using the network property in operation 640.

In operation 640, the switch may set up or cancel the layer 2 network profile using the network property and subsequently set up or cancel the VXLAN service profile using the network property.

In addition, the switch may transmit a result of setting up or canceling the VXLAN service based on the message to the at least end system.

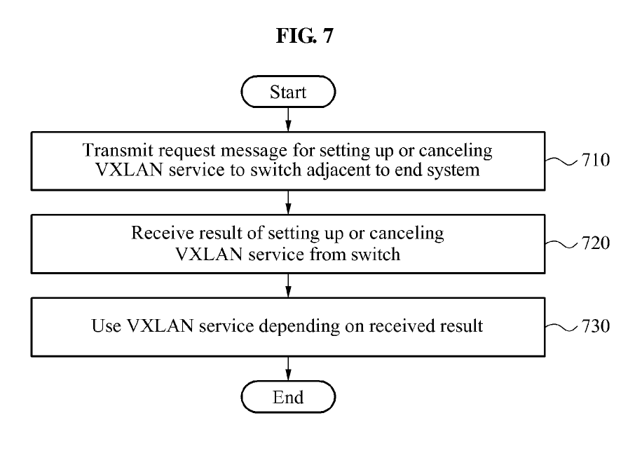

FIG. 7 is a flowchart illustrating an operating method of an end system in a VXLAN system according to an exemplary embodiment.

Referring to FIG. 7, the end system according to the present embodiment may transmit a request message for setting up or canceling a VXLAN service to a switch adjacent to the end system in operation 710. Before operation 710, the end system may retrieve a network interface connected to the adjacent switch when performing a booting process or downloading a program. Then, the end system may transmit the request message for setting up or canceling the VXLAN service through the network interface connected to the adjacent switch.

For example, when performing the booting process, the end system may transmit an association message to the adjacent switch. When downloading the program, the end system may transmit a de-association message to the adjacent switch.

The end system may receive a result of setting up or canceling the VXLAN service from the switch in operation 720.

The end system may use the VXLAN service depending on the received result in operation 730.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described with reference to the accompanying drawings, the present invention is not limited to the described exemplary embodiments. Instead, it will be apparent to those skilled in the art that various modifications and variations may be made from the foregoing descriptions.

Therefore, the scope of the present invention is not limited by the aforementioned embodiments by is defined by the appended claims and their equivalents.

What is claimed is:

1. A Virtual eXtensible Local Area Network (VXLAN) system comprising:
a database server to maintain a table comprising information about a network profile and information about a service profile and to retrieve and provide a network property corresponding to information on a requested virtual station interface (VSI) type from the table;
a network administrator to perform at least one of management operations of registering, deleting and updating the information on the VSI type;
a switch to receive a request message for setting up or canceling a VXLAN service to identify a life cycle of an end system, and to configure a VXLAN service associated with a virtual local area network (VLAN) identifier (ID) of the end system; and
at least one end system to transmit the request message for setting up or canceling the VXLAN service to the switch and to use the VXLAN service based on a result of setting up or canceling the service.

2. The VXLAN system of claim 1, wherein the VXLAN system sets up or cancels a VXLAN service for a tenant network that the at least one end system belongs to according to the life cycle of the end system.

3. An operating method of a database (DB) server in a Virtual eXtensible Local Area Network (VXLAN) system comprising a network administrator, the DB server, a switch and at least one end system, the method comprising:
maintaining a table comprising information about a network profile and information about a service profile;
receiving, from the switch, a request for information on a virtual station interface (VSI) type corresponding to a message that the switch receives from the at least one end system, the message being a request message for setting up and canceling a VXLAN service;
retrieving a network property corresponding to the VSI type from the table in response to the request; and
providing the retrieved network property to the switch.

4. The method of claim 3, wherein the retrieving of the network property comprises retrieving the network property corresponding to the VSI type based on an identifier (ID) and a version (VER) of the VSI type comprised in the message.

5. The method of claim 3, wherein the table comprises at least one of a property of a layer 2 network profile, a property of a VXLAN service profile and a multicast group address.

6. The method of claim 5, wherein the property of the layer 2 network profile and the property of the VXLAN service profile comprise at least one of a virtual local area network (VLAN) identifier (ID), Quality of Service (QoS), a bandwidth (B/W) and a VXLAN identifier (VNI).

7. The method of claim 3, further comprising receiving information on a VSI type input by the network administrator, the information on the VSI type being used by the at least one end system; and storing the input information on the VSI type in the table.

8. The method of claim 3, wherein the network administrator performs at least one of management operations of registering, deleting and updating the information on the VSI type in the table.

9. An operating method of a switch in a Virtual eXtensible Local Area Network (VXLAN) system comprising a network administrator, a database (DB) server, the switch and at least one end system, the method comprising:
receiving a request message for setting up or canceling a VXLAN service from the at least one end system;
requesting information on a virtual station interface (VSI) type corresponding to the message from the DB server;
receiving a network property corresponding to the VSI type from the DB server; and
setting up or canceling the VXLAN service using the network property.

10. The method of claim 9, wherein the setting up or canceling of the VXLAN service comprises setting up or canceling a layer 2 network profile using the network property; and setting up or canceling a VXLAN service profile using the network property.

11. The method of claim 9, wherein the network property is a network property corresponding to the VSI type in a table stored in the DB server.

12. The method of claim 9, wherein the network property comprises a property of a layer 2 network profile and a property of a VXLAN service profile.

13. The method of claim 9, further comprising transmitting a result of setting up or canceling the VXLAN service based on the message to the at least end system.

14. The method of claim 9, wherein the message is a request message for setting up or canceling a VXLAN service according to Edge Virtual Bridging (EVB) or VSI Discovery and Configuration Protocol (VDP) and comprises an identifier (ID) and version (VER) information of the VSI type.

15. The method of claim 9, further comprising registering an address of the DB server storing information on a VSI type.

16. An operating method of an end system in a Virtual eXtensible Local Area Network (VXLAN) system comprising a network administrator, a database (DB) server, a switch and at least one end system, the method comprising:
transmitting a request message for setting up or canceling a VXLAN service to a switch adjacent to the end system;
receiving a result of setting up or canceling the VXLAN service from the switch; and
using the VXLAN service according to the received result.

17. The method of claim 16, further comprising retrieving a network interface connected to the switch adjacent to the end system when the end system performs a booting process or downloads a program.

18. The method of claim 17, wherein the transmitting of the message comprises transmitting a request message for setting up or canceling the service through the network interface connected to the switch.

19. The method of claim 16, wherein the transmitting of the message comprises transmitting an association message to the switch when the end system performs the booting process.

20. The method of claim 16, wherein the transmitting of the message comprises transmitting a de-association message to the switch when the end system downloads the program.
